(19) United States
(12) Patent Application Publication
(10) Pub. No.: US 2010/0104844 A1
(43) Pub. Date: Apr. 29, 2010

(54) Flame Retardant Polyester Composite Film

(75) Inventors: John G. Rollins, Taylors, SC (US); Holger Kliesch, Ginsheim-Gustavsburg (DE)

Correspondence Address: DORITY & MANNING, P.A., POST OFFICE BOX 1449, GREENVILLE, SC, 29602-1449, US

(73) Assignee: MITSUBISHI POLYESTER FILM, INC., Greer, SC (US)

(21) Appl. No.: 12/581,993

(22) Filed: Oct. 20, 2009

Related U.S. Application Data
(60) Provisional application No. 61/107,218, filed on Oct. 21, 2008.

(51) Int. Cl. B32B 5/00; B32B 27/36; B32B 27/06; B32B 15/08

(52) U.S. Cl. 428/220; 428/480; 428/458

(57) ABSTRACT

A multi-layer composite film that has flame retardant properties. In one embodiment, the composite film includes a middle layer containing a fumable flame retardant. The middle layer is positioned between two outer film layers. The outer film layers also contain a flame retardant. The flame retardant contained in the outer layers, however, is different than the fumable flame retardant contained in the middle layer. The composite film can be used to produce numerous different articles, such as window treatments, labels, release liners, wrapping materials for the electronics industry, and the like. In one embodiment, a metallized layer may be adhered to one side of the composite film.

### RELATED APPLICATIONS

The present application is based upon and claims priority to U.S. Provisional Patent Application No. 61/107,218 filed on Oct. 21, 2008.

### BACKGROUND

Polymer films, such as polyester films, are used in a limitless variety of applications. For instance, the films are used as packaging materials, as labels, as release liners, as optical filters, as furniture laminates, and as window treatments such as blinds and shades. Polymer films are also used in the electronics industry. For instance, the films are used to wrap cable and wire.

In some applications, it is desirable for the polymer films to have flame retardant characteristics. For instance, U.S. Patent Publication No. 2006/0110613 to Ye et al., which is incorporated herein by reference, describes a metallized flame retardant polyester film comprising varying levels of phosphorous in the individual film layers. U.S. Pat. No. 7,189,451 to Kiehne et al., which is also incorporated herein by reference, discusses the addition of various flame retardants into multilayer, biaxially oriented polyester films.

Although various flame retardant films have been proposed in the past, further improvements are still needed. In this regard, the present disclosure is directed to further improvements in the construction of flame retardant films, and particularly to the construction of flame retardant polyester films.

### SUMMARY

In general, the present disclosure is directed to a flame retardant composite film that contains different flame retardants that synergistically work together to produce a film having excellent flame retardant properties.

In one embodiment, for instance, the flame retardant composite film can include at least three film layers. For example, the composite film can include a first film layer and a second film layer that each comprise a polyester polymer. At least one of the film layers or both of the film layers may further contain a first flame retardant. The composite film can further include a middle film layer positioned in between the first and second film layers. The middle film layer comprises a polyester polymer that contains a second flame retardant. The second flame retardant is different than the first flame retardant and comprises a fumable flame retardant. As used herein a “fumable” flame retardant refers to a flame retardant that generates volatile degradation products when the polymer is heated and becomes molten and specifically generates small amounts of an aldehyde, such as acetaldehyde, when the polymer is heated to temperatures greater than 175 degrees celsius. By placing the fumable flame retardant in the middle film layer, however, the volatile degradation products remain trapped within the composite film while still providing the composite film with excellent flame retardant properties.

In one embodiment, the first flame retardant and the second flame retardant comprise organophosphorous compounds that are chemically combined with the polyester polymer. For instance, the first flame retardant and the second flame retardant may be incorporated into the backbone of the polyester or may be present in the polyester polymer as a pendant group.

In one particular embodiment, the first flame retardant may comprise a butanedioic acid ester such as Bis(2-hydroxyethyl) [(6-oxide-6H-dibenzo-[c,e][1,2]oxaphosphorin-6-yl)methyl]-butanedicarboxylate. The second flame retardant, on the other hand, may comprise a phosphorous ester.

When the first flame retardant and/or the second flame retardant comprise a phosphorous compound, phosphorous may be present in each individual film layer at a concentration of at least 5,000 ppm. For instance, the flame retardant may be incorporated into each film layer such that the phosphorous concentration is from about 5,000 ppm to about 20,000 ppm, such as from about 7,000 ppm to about 12,000 ppm.

The flame retardant composite film can have any suitable thickness depending upon the particular application. In one embodiment, for instance, the composite film can have a thickness of from about 0.5 mils to about 7 mils, such as from about 1 mils to about 2 mils. The first film layer and the second film layer may each comprise from about 5 percent to about 40 percent by weight of the composite film, such as from about 10 percent to about 20 percent by weight of the composite film. The middle film layer, on the other hand, may comprise from about 20 percent to about 90 percent by weight of the composite film, such as from about 60 percent to about 80 percent by weight of the composite film. The thickness of the middle film layer, for instance, may be from about 1 mil to about 2 mils in one particular application.

The polyester polymer used to form the film layers may comprise any suitable polyester, such as polyethylene terephthalate. In one embodiment, the three film layers may be coextruded together. In this embodiment, for instance, no intermediate film layers may be present between the middle film layer and the outer first and second film layers. When coextruded, the formed film can be stretched in at least one direction. For instance, the composite film can be biaxially stretched. When the film layers are formed through extrusion, each of the polymer resins used to form the film layers may have an intrinsic viscosity of from about 0.60 IV to about 0.68 IV.

In one embodiment, a metal or metal oxide layer may be adhered to the flame retardant composite film. When a metallized layer is present on the composite film, for instance, the resulting product may be particularly well suited for producing window blinds, window shades, and other window treatments.

In one embodiment, the composite film of the present disclosure is initially formed only containing two film layers. In this embodiment, the first film layer may contain a first flame retardant while the second film layer may contain a second flame retardant which may comprise a fumable flame retardant. In this embodiment, the two layer film may be incorporated into other structures. For instance, a coating, such as a metallized coating, may be applied to the second film layer in order to encapsulate the fumable flame retardant.

In one embodiment, especially when constructing window treatments, a laminate can be formed by adhering together two composite films as described above. The composite films may be laminated together by using a flame retardant adhesive. The laminate may include a first exterior surface and a second exterior surface. In one embodiment, a first exterior surface may comprise a metallized layer. The second exterior surface, on the other hand, can be dyed any particular shade of color for producing a translucent material that has light filtering properties.

In still another embodiment, filler particles may be incorporated into one or both of the outer layers of the composite film. The filler particles may be incorporated into the outer layers, for instance, in amounts from about 5 percent to about 40 percent by weight. The fillers may be incorporated into the outer layer in order to produce a colorized opaque material. In one embodiment, for instance, titanium dioxide particles may be incorporated into one or both of the outer layers in order to produce a white composite film layer.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross sectional view of one embodiment of a flame retardant composite film made in accordance with the present disclosure;

FIG. 2 is a cross sectional view of one embodiment of a laminate that may be made in accordance with the present disclosure;

FIG. 3 is a perspective view of one embodiment of a window treatment that may be constructed in accordance with the present disclosure; and

FIG. 4 is a perspective view of another embodiment of a window treatment that made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a flame retardant composite film. The composite film is comprised of a plurality of film layers. In one embodiment, for instance, at least two of the layers are made from a polyester polymer combined with a flame retardant. In accordance with the present disclosure, a middle film layer of the composite film contains a fumable flame retardant. The middle layer can be positioned in between a pair of opposing outer film layers. One or both of the outer film layers can also contain a flame retardant. The flame retardant contained in the outer layers, however, can comprise a non-fumable flame retardant.

The present inventors discovered that encapsulating a film layer containing a fumable flame retardant between a pair of opposing outer layers wherein at least one of the outer layers contains a non-fumable flame retardant can provide various unexpected advantages and benefits. In particular, the different film layers have been found to work together to dramatically improve the flame retardant properties of the overall composite film.

For example, Underwriters Laboratories, Inc. has published standard tests for the flammability of plastic materials including films. In particular, Underwriters Laboratories, Inc. has published standard tests for flammability under the procedure designation UL 94. Specifically, test 11 of UL 94 is directed to a thin material vertical burning test.

According to test 11 of UL 94, thin materials are classified as having a “VTM” rating based upon the flammability of test specimens. Polyester films, for instance, typically have a flammability test rating of VTM-2. Composite films made in accordance with the present disclosure, on the other hand, can have a flammability test rating of VTM-0 which is the highest level of flame retardancy provided by the test. A flammability test rating of VTM-0, for instance, indicates that the test specimen, when held with its longitudinal axis vertical, stops burning within 10 seconds after two applications of 3 seconds each of a flame to the test specimen. The flame is a blue flame approximately 20 mm high produced by a burner. A flammability test rating VTM-0 also indicates the test specimen does not produce flaming particles or drops that may ignite cotton placed under the test specimen.

In order to achieve the above results, it is believed the middle film layer containing the fumable flame retardant works synergistically with the outer film layers containing different flame retardants. In fact, the present inventors discovered that the flame retardant properties of the composite film are dramatically improved in comparison to simply encapsulating a middle layer containing a fumable flame retardant in between two outer polyester layers that each do not contain a flame retardant. The flame retardant properties of the composite film of the present disclosure is also somewhat unexpected in view of U.S. Patent Application Publication 2006/0110613 which teaches a multi-layer film in which the outer most layer or layers of the film comprise higher levels of phosphorous than the inner most layer or layers.

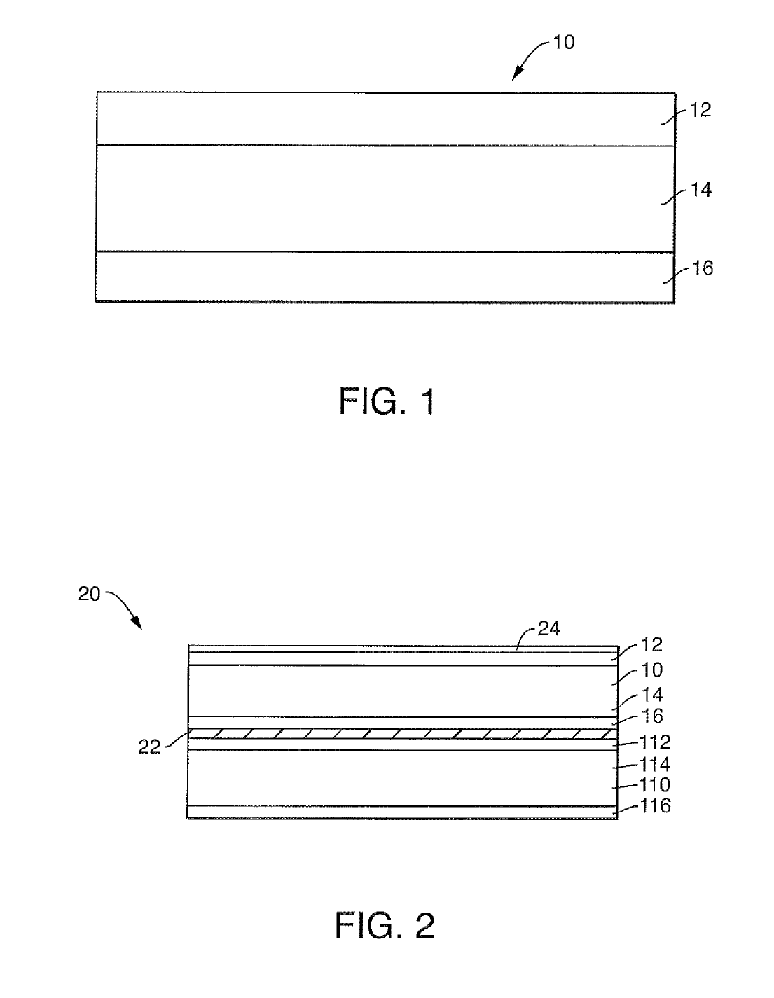

Referring to FIG. 1, for instance, for purposes of explanation, a cross section of one embodiment of a flame retardant composite film 10 made in accordance with the present disclosure is shown. The composite film 10 includes a middle film layer 14 positioned in between a first film layer 12 and a second film layer 16. It should be understood, however, that the composite film 10 may contain only two layers or more than three layers. In the embodiment illustrated in FIG. 1, the film layers are positioned directly adjacent one another. In other embodiments, however, other film layers may be positioned in between the middle layer 14 and the first and second film layers 12 and 16.

Each of the film layers, 12, 14, and 16 are made from thermoplastic polymers. In one embodiment, for instance, each film layer may be made from a polyester polymer. The polyester polymer used to produce each layer can be the same or different. Polyester polymers that may be used include, for instance, polyethylene terephthalate, polyethylene naphthalate or polybutylene terephthalate. Copolyester polymers may also be used such as polyethylene terephthalate isophthalate. Generally, any polyester film based on a polymer resulting from polycondensation of a glycol or diol with a dicarboxylic acid (or its ester equivalents) such as terephthalic acid, isophthalic acid, sebacic acid, malonic acid, adipic acid, azelaic acid, glutaric acid, suberic acid, succinic acid, and the like, or mixtures of two or more of the foregoing may be used. Suitable glycols include ethylene glycol, diethylene glycol, polyethylene glycol, and polyols such as butanediol and the like. Mixtures of two or more of the foregoing are also suitable.

In addition to a thermoplastic polymer, middle film layer 14 and at least one of the outer film layers 12 and 16 also contain a flame retardant. In one particular embodiment, for instance, both of the outer film layers 12 and 16 contain a flame retardant.

In accordance with the present disclosure, the flame retardant contained in the middle film layer 14 comprises a fumable flame retardant. The flame retardants contained in the first and second film layers 12 and 16, on the other hand, generally comprise non-fumable flame retardants. By maintaining the fumable flame retardant within the middle film layer 14, any volatile components, such as aldehyde compounds, remain trapped within the composite film 10 when the composite film is heated or exposed to an open flame. Maintaining the fumable flame retardant in the middle film layer 14 is believed to also increase the ability of the flame retardant to improve the overall flame retardant properties of the composite film. For instance, in one embodiment, the fumable flame retardant may comprise a phosphorous compound. Maintaining the fumable flame retardant in the middle film layer 14 inhibits phosphorous from being released from the middle film layer and thus maintaining the flame retardant properties of the composite film.

As described above, one or both of the outer film layers 12 and 16 may also contain a flame retardant that is different from the flame retardant contained in the middle film layer. The present inventors found that the flame retardant contained in the outer film layers works synergistically with the fumable flame retardant contained in the middle layer. This construction can produce an overall composite film having excellent flame retardant properties. In particular, the composite film of the present disclosure has dramatically improved flame retardant properties in comparison to a similar composite film that does not contain a flame retardant in the outer layers but contains a fumable flame retardant in the middle layer.

The flame retardant contained in the first film layer 12 and the second film layer 16 can be the same or different. Examples of suitable flame retardants include halogen compounds, such as organic bromine compounds, organic chlorine compounds or organic nitrogen compounds. Other flame retardants include metal hydroxides or metal oxide trihydrates.

The flame retardant contained within the film layers 12 and 16 may be mixed with the thermoplastic polymer or may be chemically combined with the polymer. The flame retardant may be chemically combined with the polymer by, for instance, covalent bonds. The flame retardant, for instance, may be chemically combined with a polyester polymer by being in the backbone of the polymer or may comprise a pendant group.

Flame retardants that are particularly well suited for use in the first and second film layers are phosphorous compounds, such as organophosphorous compounds. Such compounds not only have excellent flame retardant properties but are also capable of being chemically combined with thermoplastic polymers, such as polyester. Examples of such flame retardants are carboxyphosphinic acids including anhydrides and dimethyl methanephosphate. Other phosphorous compounds include various phosphorousesters, such as butanedioic acid esters. One particular embodiment of a butanedionic acid ester comprises Bis(2-hydroxyethyl) [(6-oxide-6H-dibenzo-[c,e][1,2]oxaphosphorin-6-yl)methyl]-butanedicarboxylate (also referred to as Butanedioic acid, [6-oxido-6H-dibenz[c,e][1,2]oxaphosphorin-6-yl)methyl]-, bis(2-hydroxyethyl)ester), which also has the structure as follows:

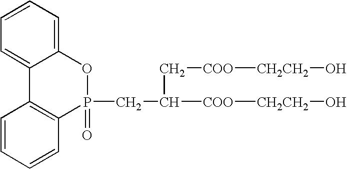

As described above, the middle film layer contains a fumable flame retardant that is different than the flame retardants contained in the outer layers. The fumable flame retardant, for instance, may comprise a phosphorous compound, such as an organophosphorous compound. In one embodiment, for instance, the fumable flame retardant comprises a phosphorous ester. The fumable flame retardant may be chemically combined with the thermoplastic polymer, such as the polyester polymer. For example, the fumable flame retardant may be covalently bonded to the polyester polymer by being incorporated into the backbone of the polymer or may be included as a pendant group. One particular embodiment of a fumable flame retardant that may be used in the middle film layer 14 is commercially available from Invista under the trade name 8934H. 8934H comprises a modified polyethylene terephthalate polymer containing a fumable flame retardant that comprises a phosphorous compound. When exposed to a flame, the modified polyethylene terephthalate polymer generates small amounts of volatile degradation products including acetaldehyde (at temperatures of about 175 degrees celsius).

The amount of flame retardant contained in each film layer may depend upon various factors including the particular application for which the composite film is to be used. In general, a flame retardant may be incorporated into each film layer in an amount from about 0.1 percent to about 5 percent by weight depending upon the particular flame retardant chosen. When the flame retardant comprises a phosphorous, for instance, the flame retardant may be incorporated into each film layer at a concentration of from about 5,000 ppm to about 100,000 ppm, such as from about 5,000 ppm to about 20,000 ppm. In one particular embodiment, for instance, the flame retardant may be contained in the film layer in amount from about 8,000 ppm to about 10,000 ppm.

In the embodiment illustrated in FIG. 1, a three layer composite film is shown. It should be understood, however, that in an alternative embodiment, the composite film may only contain two layers, namely the outer film layer 12 and the middle film layer 14. In this embodiment, for instance, the middle film layer containing the fumable flame retardant may be coated with any suitable material in order to encapsulate the fumable flame retardant. In one particular embodiment, for instance, a two layer composite film may be laminated to another two layer composite film such that the resulting composite film contains two middle layers, both containing a fumable flame retardant.

In order to form the composite film of the present disclosure, in one embodiment, the film layers can be coextruded together. For example, each of the polymers or polymer blends used to form the layers can be melted separately and then extruded together as a single, but layered, sheet onto a polished revolving casting drum to form a cast multilayer film. The composite film is quickly cooled and then stretch oriented in one or more directions to impart strength and toughness to the composite film. The composite film, for instance, can be uniaxially stretched or biaxially stretched. Generally, stretching occurs in a temperature range from about the second order transition temperature of the polyester polymer to below the temperature at which the polymer softens and melts. Where necessary, the composite film can also be heat treated after stretching to “lock-in” the properties of the polyester film layer by further crystallizing the film. The crystallization imparts stability and good tensile properties to the composite film. Such heat treatment for a polyester film layer is generally conducted at a temperature of from about 190° C. to about 240° C. For instance, in one embodiment, the composite film can be exposed to heat of from about 215° C. to about 225° C. for a period of about 1 second to about 20 seconds, such as from about 2 seconds to about 10 seconds.

The amount the film is stretched prior to being heat treated can depend upon various factors. When uniaxially stretched, the film can be stretched in one direction (such as the machine direction or the cross machine direction) in an amount from about 1 times to about 4 times its original length, such as from about 3 times to about 4 times its original length. When biaxially stretched, the film can then be stretched in a perpendicular direction in an amount from about 1 times to about 4 times its original length, such as from about 3 times to about 4 times its original length.

When coextruding the film layers together, the polymer resin used to form the layers can have an intrinsic viscosity of from about 0.6 IV to about 0.7 IV. For example, the intrinsic viscosity of the polymer resin for each layer can be from about 0.61 IV to about 0.63 IV.

It should be understood, however, that the individual film layers can, in an alternative embodiment, be formed and then attached together after formation. In addition, the composite film 10 can include additional film layers if desired.

The final thickness of the composite film can vary depending upon various factors and circumstances, such as the process used to form the film and the end use application. In general, for instance, the composite film can have a thickness of from about 0.5 mil to about 7 mils or greater. In one particular application, the composite film can have a thickness of from about 1 mil to about 2 mils. The middle film layer 14, for instance, can generally have a thickness of from about 0.5 mil to about 1.5 mils in the above embodiment.

In general, the first film layer 12 and the second film layer 16 each comprise from about 5 percent to about 40 percent of the thickness of the composite film, such as from about 10 percent to about 20 percent of the thickness of the composite film. The middle film layer 14, on the other hand, can generally comprise from about 20 percent to about 90 percent of the thickness of the composite film, such as from about 60 percent to 80 percent of the thickness of the composite film. In one particular embodiment, the first film layer 12 and the second film layer 16 may each comprise about 15 percent of the total thickness of the composite film, while the middle film layer 14 comprises about 70 percent of the total thickness of the composite film.

After being formed, the composite film 10 can be translucent, transparent, or opaque. For example, in one embodiment, each of the film layers can be made from thermoplastic polymers containing flame retardants that produce a transparent composite film. In other embodiments, however, it may be desirable that one or more of the film layers be translucent or opaque. For example, in one embodiment, the composite film can be died using, for instance, a glycol soluble die.

In still another embodiment, one or more fillers can be incorporated into the first film layer 12 and/or the second film layer 16 in order to provide color to the composite film and possible make the composite film opaque. The pigments may comprise, for instance, titanium dioxide particles, metal oxide particles, carbon particles, and the like. The fillers can have a plate-like shape or can have a rhombohedral shape or a rounded shape. In general, any suitable filler may be incorporated into the film layers in order to provide the composite film with the proper color. The composite film, for instance, can be white, black, gray, or any other suitable color.

When incorporating a filler into either the first film layer 12 or the second film layer 16, the filler can comprise from about 5 percent to about 50 percent by weight of the film layer. For instance, the filler may be present in a amount of from about 10 percent to about 40 percent by weight, such as from about 20 percent to about 35 percent by weight of the film layer.

In addition to fillers, the polymer film layers can also contain any suitable additives. Such additives may include, for instance, antioxidants, delusterants, fillers, antistatic agents, and the like. In one embodiment, for instance, one or more of the outer film layers may contain a UV blocker, especially when the composite film is being used to construct window treatments.

The flame retardant composite film of the present disclosure can be used in an almost limitless variety of different applications. For example, in one embodiment, the flame retardant composite film may be used as a label or in the electronics field. When used in the electronics filed, for instance, the film may be used to wrap cable or electrical wires. In addition, the film can be laminated to numerous different articles or parts. For instance, the film is well suited to being laminated to metal, such as steel products. In one embodiment, for instance, the film may be used as a flame retardant coating on a building product, such as a garage door. As described above, the composite film may also be used to construct various window treatments. Such window treatments may include window shades and blinds.

In addition to the three film layers as shown in FIG. 1, the flame retardant composite film of the present disclosure may include various other film layers and coatings. For example, when the composite film 10 is used as a label, an adhesive layer may be applied to one of the exterior surfaces of the composite film. The adhesive that is applied to the composite film can depend upon the particular application for the label. In one embodiment, for instance, a flame retardant adhesive may be applied to the composite film.

When an adhesive layer is applied to the composite film, a release layer may be used to cover the adhesive layer prior to use. In this regard, a release layer comprising a paper or film having a low adhesion surface may be placed over the adhesive layer and configured to be removed prior to use. In one embodiment, for instance, the release layer may comprise a sheet-like substrate having a silicone coating applied to one surface.

In addition to adhesive layers, in other embodiment, various different coatings may be applied to the composite film so that the film will readily accept printed matter.

In still another embodiment, a metallized layer may be applied to an exterior surface of the composite film. The metallized layer, for instance, may be made from a metal or metal oxide. When applying a metallized layer to the composite film, in one embodiment, a coating composition may first be applied to the composite film for improving adhesion between the composite film and a metal or metal oxide layer. The coating composition, for instance, may be formed from, for instance, a phthalic acid, such as isophthalic acid, a sulfomonomer, and a diol.

A metal or metal oxide layer may be formed, for instance, according to a vacuum deposition process. In this type of process, a stream of metal vapor or atoms are deposited onto the dried coating by vacuum deposition. This is effected by heating the metal in a high vacuum, preferably in the range of 10⁻³ to about 10⁻⁵ torr, to a temperature above the melting point of the metal such that the vapor pressure of the metal exceeds about 10⁻² torr or is affected by subjecting the metal to a stream of bombarding ions whereby the metal or metal oxide is removed by mass transfer “sputtering”.

When the above conditions are achieved, the metal is vaporized or sputtered, emitting metal vapors or atoms in all directions. These vapors or atoms impinge on the film surface, condense and thereby form a thin metallic coating on the film. Metals applicable to this process are zinc, nickel, silver, copper, gold, indium, tin, stainless steel, chromium, titanium, aluminum, oxides of such metals, and the like.

The thickness of the metal coating can depend upon the particular application and various other factors. In one embodiment, for instance, the metal layer can have a thickness of less than about 1000 angstroms, such as from about 300 to about 600 angstroms. In still other embodiments, the thickness of the metal layer may be less than about 100 angstroms.

The thickness of the metal coating and the type of metal used to produce the coating may depend upon the particular application. In some embodiments, for instance, a reflective coating can be produced on the composite film that does not permit light transfer through the film. In other embodiments, however, the metal layer may be translucent.

In one particular embodiment of the present disclosure, the flame retardant composite film as shown in FIG. 1 may be incorporated into a laminate. In one embodiment, for instance, the laminate may be used to produce a window treatment, such as a window blind or window shade. Referring to FIG. 2, for instance, one embodiment of a laminate 20 made in accordance with the present disclosure is shown. Like reference numerals have been used to indicate similar elements or features. In this embodiment, the laminate 20 comprises adhering two flame retardant composite films as shown in FIG. 1 together. In other embodiments, however, the flame retardant composite film 10 of the present disclosure may be laminated to other films and substrates.

As shown in FIG. 2, the laminate 20 includes a first flame retardant multi-layer composite film 10 adhered to a second flame retardant multilayered composite film 110. The first composite film is made in accordance with the present disclosure and includes a middle film layer 14 positioned in between a first film layer 12 and a second film layer 16. Similarly, the composite film 110 includes a middle film layer 114 positioned in between two outer film layers 112 and 116. In accordance with the present disclosure, the middle film layers 14 and 114 contain a fumeable flame retardant. The outer film layers 12, 16, 112, and 116 also contain a flame retardant. The composite film 10 is adhered to the second composite film 110 by an adhesive 22. The adhesive 22 may comprise a flame retardant adhesive.

The laminate 20 as shown in FIG. 2 further includes a metallized layer 24 which forms an exterior surface of the laminate. In one embodiment, for instance, the metallized layer 24 may comprise aluminum.

The laminate 20 as shown in FIG. 2 is particularly well suited for producing window treatments, such as shades or blinds. In one embodiment, for instance, the metallized layer 24 can be configured to reflect a portion of light but yet remain translucent. The second composite film 110 can be dyed to provide an overall product that is still translucent but blocks or filters much of the light that contacts the material. For instance, in embodiment, the laminate 20 can have an overall dark color, such as a dark gray color.

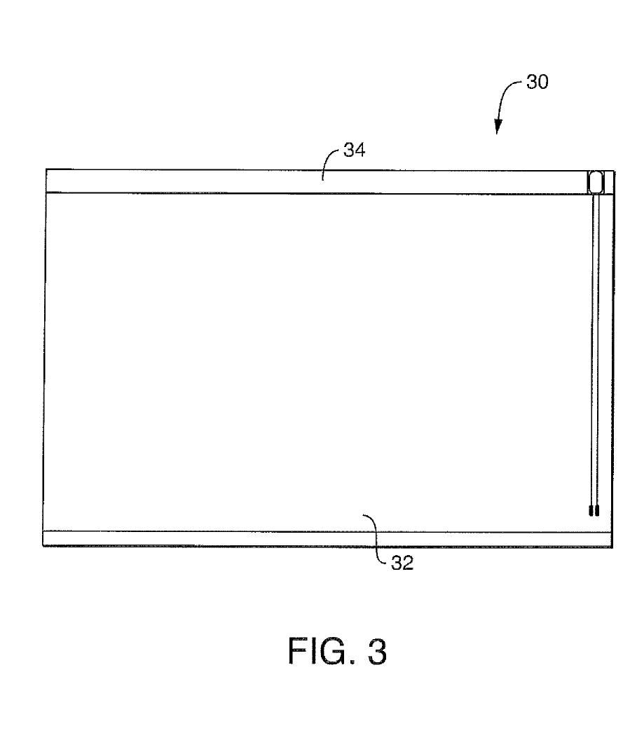

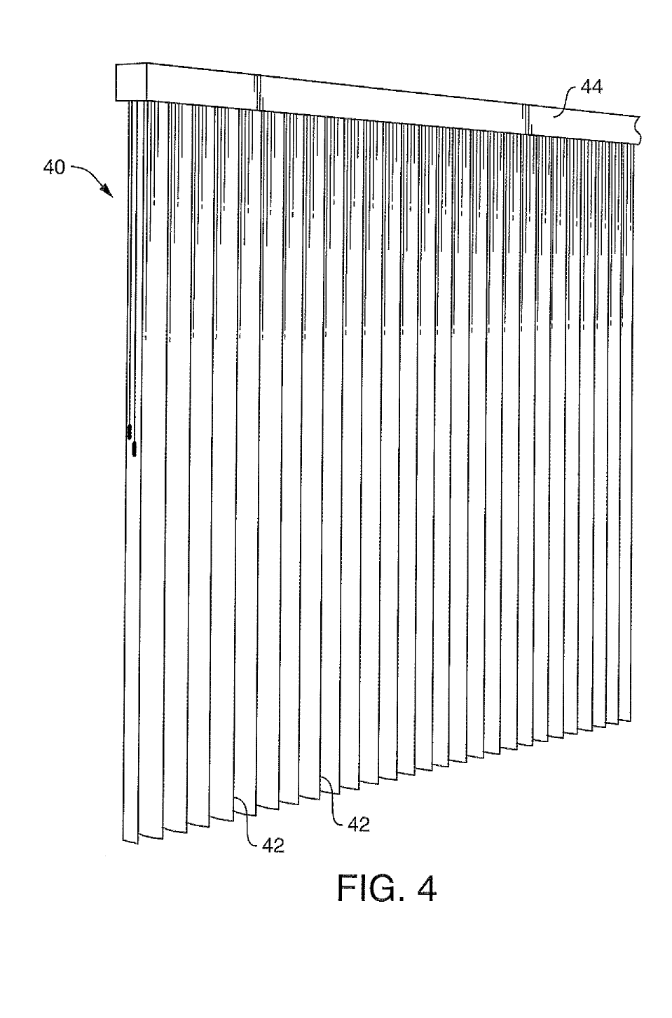

For example, referring to FIG. 3, a window shade 30 is shown made in accordance with the present disclosure. The window shade 30 includes a shade 32 made from the laminate 20 as shown in FIG. 2. The shade 32 can be connected to a header 34. The header 34 may contain a reel that allows the shade 32 to move up and down depending upon the user's preference. The shade 32 as shown in FIG. 3 can be constructed so as to be translucent or opaque.

Referring to FIG. 4, another embodiment of a window treatment made in accordance with the present disclosure is shown. In this embodiment, the window treatment comprises a vertical blind 40. The vertical blind 40 contains a plurality of individual blinds 42 made from the composite film of the present disclosure. The blinds 42 are connected to a header 44 which includes controls for opening and closing the blinds and/or rotating the blinds.

The present disclosure may be better understood with reference to the following example.

### EXAMPLE

A flame retardant composite film as shown in FIG. 1 was constructed and tested for its flammability according to Underwriter's Laboratories Test No. UL94. The composite film had a thickness of 36 microns.

The flame retardant composite film contained three film layers. Each of the film layers was made from a polyester polymer chemically modified by a flame retardant. The polyester polymer comprised polyethylene terephthalate.

In particular, the composite film included two outer layers that were made from a polyethylene terephthalate resin obtained from Invista and sold under the product designation VA09. The polyethylene terephthalate resin contained an organophosphate flame retardant. The flame retardant was Bis(2-hydroxyethyl) [(6-oxide-6H-dibenzo-[c,e][1,2]oxaphosphorin-6-yl)methyl]-butanedicarboxylate. The flame retardant was contained in the polymer at a concentration of approximately 9,000 ppm.

The middle film layer of the composite film was made from a modified polyethylene/terephthalate resin also obtained from Invista under the product designation 8934H. The polymer resin contained a fuming flame retardant. The flame retardant was a phosphorous ester. The flame retardant was present in the polymer at a concentration of about 9,000 ppm.

The composite film was formed in a coextrusion process as described above. The film was biaxially stretched during the process.

The film was then provided to Underwriter's Laboratory and tested for flammability according to test no. 11 in accordance with UL 94. The composite film was found to have a flammability rating of VTM-0.

These and other modifications and variations to the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only, and is not intended to limit the invention.

What is claimed:

1. A flame retardant composite film comprising:
a first film layer comprising a polyester polymer containing a first flame retardant; and
a second film layer comprising a polyester polymer containing a second flame retardant that is different than the first flame retardant, the second flame retardant comprising a fumable flame retardant.

2. A flame retardant composite film as defined in claim 1, further comprising a third film layer, the second middle film layer being positioned in between the first film layer and the third film layer.

3. A flame retardant composite film as defined in claim 2, wherein the third film layer comprises a polyester polymer.

4. A flame retardant composite film as defined in claim 3, wherein the third film layer also contains a flame retardant that is different than the second flame retardant.

5. A flame retardant composite film as defined in claim 4, wherein the flame retardant contained in the third film layer comprises the first flame retardant.

6. A flame retardant composite film as defined in claim 5, wherein the first flame retardant and the second flame retardant comprise organophosphorous compounds.

7. A flame retardant composite film as defined in claim 5, wherein the first flame retardant and the second flame retardant are chemically combined with the polyester polymers.

8. A flame retardant composite as defined in claim 5, wherein the second flame retardant comprises a phosphorous ester.

9. A flame retardant composite film as defined in claim 7, wherein the first flame retardant and the second flame retardant are chemically combined with the polyester polymers such that the first and second flame retardants are incorporated into a backbone of the polyester polymers.

10. A flame retardant composite film as defined in claim 6, wherein the first flame retardant comprises Bis(2-hydroxyethyl) [(6-oxide-6H-dibenzo[c,e][1,2]oxaphosphorin-6-yl)methyl]-butanedicarboxylate.

11. A flame retardant composite film as defined in claim 5, wherein the first and third film layers and the second middle film layer have been coextruded.

12. A flame retardant composite film as defined in claim 7, wherein the composite film has been stretched in at least one direction.

13. A flame retardant composite film as defined in claim 12, wherein the composite film has been biaxially stretched.

14. A flame retardant composite film as defined in claim 5, wherein phosphorous is contained in the first film layer, in the second film layer, and in the third film layer at a concentration of from about 5,000 ppm to about 20,000 ppm.

15. A flame retardant composite film as defined in claim 5, wherein the composite film, when tested according to UL-94, has a VTM of 0.

16. A flame retardant composite film as defined in claim 5, wherein the composite film has a thickness of from about 0.5 mils to about 7 mils.

17. A flame retardant composite film as defined in claim 16, wherein the first film layer comprises from about 5 percent to about 40 percent by weight of the composite film, the third film layer comprises from about 5 percent to about 40 percent by weight of the composite film, and the second film layer comprises from about 20 percent to about 90 percent by weight of the composite film.

18. A flame retardant composite film as defined in claim 5, wherein the first film layer comprises from about 10 percent to about 20 percent by weight of the composite film, the third film layer comprises from about 10 percent to about 20 percent by weight of the composite film, and the second film layer comprises from about 60 percent to about 80 percent by weight of the composite film, and wherein the composite film has a thickness of from about 1 mil to about 2 mils.

19. A flame retardant composite film as defined in claim 5, wherein the first film layer contains a filler that colorizes the layer.

20. A flame retardant composite film as defined in claim 5, further comprising a metallized layer adhered to the first film layer.

21. A flame retardant composite film as defined in claim 6, wherein the first flame retardant and the second flame retardant are chemically combined with the polyester polymers, the first flame retardant comprising Bis(2-hydroxyethyl) [(6-oxide-6H-dibenzo-[c,e][1,2]oxaphosphorin-6-yl)methyl]-butanedicarboxylate, the second flame retardant comprising a phosphorous ester, the composite film being coextruded and biaxially stretched, the polyester polymer contained in the film layers comprising a polyethylene terephthalate, the composite film having a thickness of from about 1 mil to about 2 mils, the second film layer comprising from about 60 percent to about 80 percent by weight of the composite film, and wherein the composite film, when tested according to UL-94, has a VTM of 0.

22. A flame retardant composite film as defined in claim 1, wherein the polyester polymers used to form the film layers have an intrinsic viscosity of from about 0.6IV to about 0.68IV.

23. A laminate comprising two composite films as defined in claim 5 adhered together.

24. A laminate as defined in claim 23, wherein the laminate includes a first exterior surface and a second and opposite exterior surface, the first exterior surface comprising a metallized layer.

25. A window blind or shade comprising the laminate defined in claim 23.
